(19) United States
(12) Patent Application Publication
(10) Pub. No.: US 2026/0118868 A1
(43) Pub. Date: Apr. 30, 2026

(54) SYSTEMS AND METHODS OF FAILURE AND LIFE CYCLE PREDICTION AND MANAGEMENT

(71) Applicant: Sensia Netherlands B.V., Rotterdam (NL)

(72) Inventors: Harshkumar Patel, Houston, TX (US); Jonathan Wun Shiung Chong, Calgary (CA)

(73) Assignee: Sensia Netherlands B.V., Rotterdam (NL)

(21) Appl. No.: 19/367,127

(22) Filed: Oct. 23, 2025

Related U.S. Application Data
(60) Provisional application No. 63/711,357, filed on Oct. 24, 2024.

(51) Int. Cl. G05B 23/02

(52) U.S. Cl. CPC G05B 23/0283; G05B 23/024; G05B 23/027

(57) ABSTRACT

Systems and methods provided herein relate to a well site or other plant. Systems and methods are employed to determine faults and/or life cycle. A failure prediction engine can be used. The failure prediction engine includes a data quality engine, a features engine, condition detectors, failure models, and an alarm configurator.

### CROSS-REFERENCE TO RELATED PATENT APPLICATIONS

This application claims the benefit of and priority to U.S. Provisional Application No. 63/711,357, filed Oct. 24, 2024, incorporated herein by reference in its entirety.

### BACKGROUND

Various types of equipment utilized in various processes can be subject to degradation and/or failure. For example, components used in petroleum and gas production, processing, and refinement can be subject to wear and tear which affects the life cycle of the components. Such components include but are not limited to pump systems, valves, piping, heat exchangers, and plumbing utilized to move fluid in a well in a subterranean environment.

### SUMMARY OF THE INVENTION

Some embodiments relate to a failure predictor (e.g., an advanced failure prediction (AFP) engine) configured to provide AFP outputs. The outputs can be useful for variety of use cases from real-time surveillance and pump control to periodic planning such as pump configurations, operations strategy, workover planning, inventory management, failure diagnostics, and various other business intelligence type analytics.

Some embodiments relate to an AFP engine that has a plug-and-play design and works with available surveillance measurements. The engine is configured to automatically enable/disable condition detectors and to automatically adjust other components, predictions and confidence in response to the availability and quality of data.

Some embodiments relate to an AFP engine that has a purpose-built data quality engine which makes it robust to a variety of streaming data quality issues including gauge failures.

Some embodiments relate to an AFP engine that provides explainable and consistent predictions. The AFP engine uses an architectural design and explainable AI, where each output of the engine made by internal components can be traced and/or each output can be explained. The outputs can be used for diagnosis, causal analysis, and upgrading of various components of the engine.

Some embodiments relate to an AFP engine with a modular architecture that offers several levels of tuning, starting with alarm configurator and failure model tuning, followed by condition detector tuning, followed by feature engine tuning and data quality engine tuning. The AFP engine has an architectural design that makes it easy to update or add new components, detectors, models, etc. Depending on performance drifts, changes in requirements and use cases, and availability of new information, the AFP engine can be progressively customized, upgraded, and/or extended (e.g., for new sensor technologies providing additional information not covered by previous detectors). The engine architecture can be used for condition monitoring and failure prediction of any other industrial equipment.

Some embodiments relate to a quality engine, feature engine, alarm configurator, and performance report generators that are configurable and general-purpose libraries that can be easily repurposed for other types of time-series data based industrial surveillance applications.

Some embodiments relate to a pump system for a pump disposed within a well. The pump system includes a controller with a failure prediction engine configured to predict life cycle and/or failure. The failure prediction engine includes a data quality (DQ) engine configured to identify receive real-time streaming data associated with the well and provide data quality flags and a features engine configured to extract patterns. The features engine is configured to receive the data quality flags from data quality engine and the real-time streaming.

In some embodiments, the data quality flags indicate missing parameters or readings, or outlier parameters or readings. In some embodiments, the data quality engine is configured as an application. In some embodiments, the features engine is configured to denoise the real-time streaming data and generate key performance statistics. In some embodiments, the key performance statistics comprise averages, rate of change, and certainty.

In some embodiments, the failure prediction engine is configured to automatically enable/disable condition detectors in response to the data quality flags. In some embodiments, the features engine uses advanced multivariate unsupervised machine-learning techniques to detect the patterns and shifts in the patterns across multiple-signals and at multiple-timescales.

Some embodiments relate to a failure prediction engine for energy resource processing. The failure prediction engine includes a data quality engine configured to identify receive real-time streaming data associated with the energy resource processing and provide data quality flags, a features engine configured to extract patterns, and condition detectors. The features engine is configured to receive the data quality flags from the data quality engine and the real-time streaming. Each condition detector is configured to detect a condition, and the failure prediction engine is configured to automatically enable/disable at least one of the condition detectors in response to the data quality flags.

In some embodiments, the failure prediction engine also includes models including a risk of failure model and remaining useful life model. In some embodiments, the failure prediction engine also includes models an alarm configurator configured to provide various options for users to set conditions to trigger alarms in response at a risk of failure, remaining life, confidence level, or run time.

In some embodiments, the failure prediction engine is configured to automatically enable/disable condition detectors in response to the data quality flags. In some embodiments, the features engine is configured to denoise the real-time streaming data and generate key performance statistics. In some embodiments, the key performance statistics comprise averages, rate of change, and certainty.

In some embodiments, the failure prediction engine is configured to automatically enable/disable condition detectors in response to the data quality flags. In some embodiments, the features engine uses advanced multivariate unsupervised machine-learning techniques to detect the patterns and shifts in the patterns across multiple-signals and at multiple-timescales.

Some embodiments relate to a well site including a pump system for a pump disposed within a well. The well site includes a failure prediction engine which includes a data quality engine, a features engine, condition detectors, failure models, and an alarm generator. The failure prediction engine is configured to provide tuning for the alarm configurator and the failure models, tuning for the condition detectors, and tuning a feature engine.

In some embodiments, the failure prediction engine is configured to provide tuning for the data quality engine. In some embodiments, the failure prediction engine is configured to update the failure models and the detectors based upon a specific population failure type or a specific use case requirement. In some embodiments, the failure prediction engine is configured tune the detectors based upon performance drift. In some embodiments, the failure prediction engine is configured to modify the feature engine in response to new sensors.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a well site including a rod pump system, according to some embodiments.

FIG. 2 a schematic drawing of a well site including an electric submersible pumping system, according to some embodiments.

FIG. 3 is a schematic block diagram of a failure prediction engine which can be used with the well sites illustrated in FIGS. 1 and 2, according to some embodiments.

FIG. 4 is a schematic block diagram of a tuning operation for the failure prediction engine illustrated in FIG. 3, according to some embodiments.

FIG. 5 is a schematic block diagram of an output for the failure prediction engine illustrated in FIG. 3, according to some embodiments.

FIG. 6 is a flow diagram of an update operation for the failure prediction engine illustrated in FIG. 3, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Predicting life cycle and/or failure of oilfield equipment can be a challenge for the industry, both in terms of accuracy, actionability and scalability. Life cycle refers to the overall life of a physical asset such as a piece of machinery, equipment, or other component. Determining a life cycle or expected failure of a component can have significant advantages in supporting the overall productivity of a process or system. Multiple factors can affect life cycle management and predictions of life cycle including but not limited to unstructured environments (dynamic, evolving over time), limitations in measurements and information, large variability in equipment configurations and operational states, and high cost barriers. These conditions occur across a spectrum of conditions, but generally the further upstream the equipment (closer to well/subsurface), the more challenging the problem. Some embodiments of systems and methods discussed herein apply to upstream equipment. Some embodiments of systems and methods discussed herein apply to various equipment types including but not limited to electrical submersible pumps (ESPs), sucker rod pumps, gas lift equipment, valves, surface pumps, sensors, separators, etc. The equipment includes stationary and rotary equipment including but not limited to pump systems, valves, piping, heat exchangers, and plumbing utilized to move fluid in a well in a subterranean environment.

In some embodiments, systems and methods predict failure of electrical submersible pumps used in the oil and gas wells. In some embodiments, the prediction is made even though uncontrolled subsurface environments of oil field and complex failure modes exist. Baseline human expert solutions generally do not exist for this problem. In some embodiments, the systems and methods achieve better performance than conventional rule of thumb remaining useful life determinations, field level statistics, or empirical correlations that have been relied upon to estimate run life for planning purposes. In some embodiments, the systems and methods can use real-time monitoring to identify more than some specific type of flow-related issues. In some embodiments, the systems and methods predict pump failure before failure without pulling the pump out of well, without disassembly and without detailed inspection to confirm actual failure. In some embodiments, the systems and methods provide reliable estimation of the remaining useful life of a pump and detect its failure better than human-expert or other conventional solutions.

In some embodiments, systems and methods predict failure and leverage machine learning while using online monitoring. In some embodiments, systems and methods predict failure using machine learning that is not entirely on offline system. In some embodiments, systems and methods mitigate generalizability outside of the target dataset and high data requirements and yet provide a general purpose and scalable system that works with available pump surveillance data and offers actionable, explainable, and reliable predictions (e.g., for pump condition, risk of failure, and remaining useful life). In some embodiments, the prediction can be used in an optimization context to optimize any setting, such as injection, pump speed and/or production choke.

In some embodiments, an advanced failure prediction (AFP) engine monitors real-time measurements from a pump and continuously outputs risk of failure and remaining useful life for a pump. The AFP engine can be embodied as an application. Different levels of tuning and upgrades can be applied to the AFP engine. In some embodiments, AFP engine outputs are useful for variety of use cases from real-time surveillance and pump control to periodic planning such as pump configurations, operations strategizing, workover planning, inventory management, failure diagnostics, and various other business intelligence type analytics.

In some embodiments, the AFP engine has a plug-and-play design and works with available surveillance measurements. Depending on the availability and quality of data, the AFP engine automatically enables/disables condition detectors and adjusts other components and predictions and confidence. AFP engine has a purpose-built data quality engine which makes it robust to a variety of streaming data quality issues including gauge failures in some embodiments.

In some embodiments, the AFP engine provides explainable and consistent predictions. Because of the unique architectural design and explainable AI, each output of the engine decision made by the internal components can be traced and each output can be explained. This traceability assists diagnosis, causal analysis, and upgrading of various components of the engine in some embodiments.

In some embodiments, the AFP engine has a modular architecture of the engine that offers several levels of tuning. The levels can start with tuning an alarm configurator and failure models, followed by tuning condition detectors, followed by tuning a feature engine and a data quality engine. The architectural design makes it easy to update or add new components, detectors, models, etc. Depending on performance drifts, changes in requirements and use cases, and availability of new information, the AFP engine can be progressively customized, upgraded, and/or extended (e.g., new sensor technologies providing additional information not covered by previous detectors). In some embodiments, the AFP engine architecture described is general-purpose and can be applied to condition monitoring and failure prediction of any industrial equipment. In some embodiments, the AFP engine includes a data quality engine, a feature engine, an alarm configurator, and performance report generators that are configurable and use general-purpose libraries which can be easily repurposed for other types of time-series data based industrial surveillance applications.

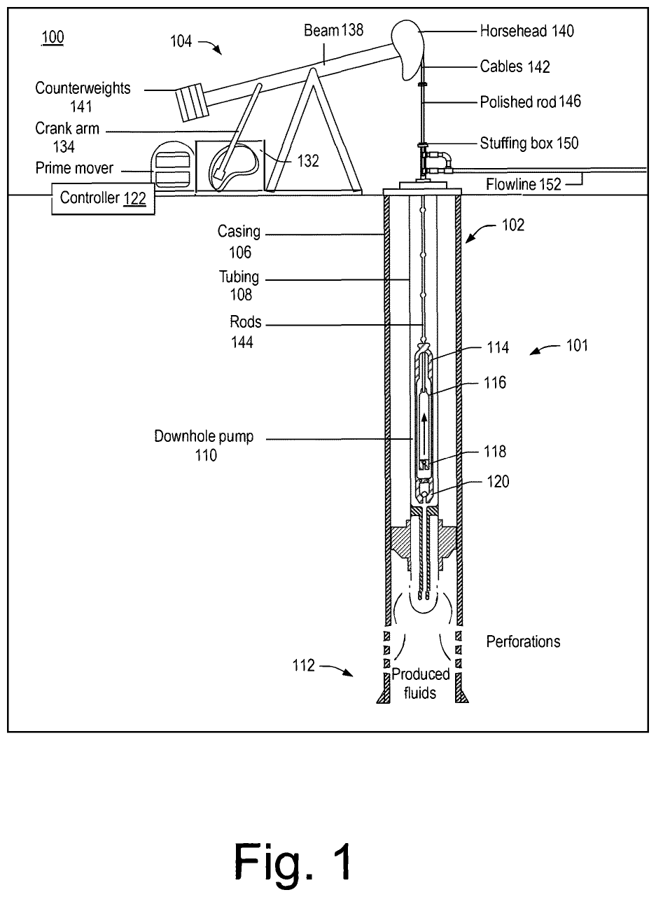

Referring now to FIG. 1, a pump system 100 is shown, according to some embodiments. The system 100 includes a pump assembly 101 as driven by a pump drive system 104 that is operatively coupled to a controller 122. For example, the pump assembly 101 and drive system 104 may be arranged as a beam pump. In some embodiments, the system 100 further includes a walking beam 138 that reciprocates a rod string 144. The rod string 144 may include a polished rod portion 146 that can move in a bore of a stuffing box 150 of a well head assembly that includes a discharge port in fluid communication with a flowline 152. The rod string 144 may be suspended from the walking beam 138 via one or more cables 142 hung from a horse head 140 for actuating a downhole pump 110 of the pump assembly 101 where the downhole pump 110 is positioned in a well 102. For example, the well 102 may be in a subterranean environment, and the downhole pump 110 may be positioned near a bottom 112 of the well 102.

In some embodiments, the well 102 may be a cased well or an open well. For example, a partially cased well may include an open well portion or portions. As shown in FIG. 1, the well 102 includes casing 106 that defines a cased bore where tubing 108 is disposed in the cased bore. An annular space may exist between an outer surface of the tubing 108 and an inner surface of the casing 106.

In some embodiments, the walking beam 138 is actuated by a pitman arm (or pitman arms), which is reciprocated by a crank arm (or crank arms) 134 driven by a prime mover 130 (e.g., electric motor, etc.). For example, the prime mover 130 may be coupled to the crank arm 134 through a gear reduction mechanism, such as gears of a gearbox 132. In some cases, the prime mover 130 is a three-phase AC induction motor that can be controlled via circuitry of the controller 122, which may be connected to a power supply. The gearbox 132 of the pump drive system 104 may convert electric motor torque to a low speed, high torque output for driving the crank arm 134. The crank arm 134 may be operatively coupled to one or more counterweights 141 that serve to balance the rod string 144 and other equipment as suspended from the horse head 140 of the walking beam 138. A counterbalance may be provided by an air cylinder such as those found on air-balanced units.

In some embodiments, the downhole pump 110 is a reciprocating type of pump that includes a plunger 116 attached to an end of the rod string 144 and a pump barrel 114, which may be attached to an end of the tubing 108 in the well 102. The plunger 116 can include a traveling valve 118 and a standing valve 120 positioned at or near a bottom of the pump barrel 114. During operation, for an up stroke where the rod string 144 translates upwardly, the traveling valve 118 can close and lift fluid (e.g., oil, water, etc.) above the plunger 116 to a top of the well 102 and the standing valve 120 can open to allow additional fluid from a reservoir to flow into the pump barrel 114. As to a down stroke where the rod string 144 translates downwardly, the traveling valve 118 can open and the standing valve 120 can close to prepare for a subsequent cycle. Operation of the downhole pump 110 may be controlled such that a fluid level is maintained in the pump barrel 114 where the fluid level can be sufficient to maintain the lower end of the rod string 144 in the fluid over its entire stroke.

As an example, the system 100 can include a beam pump system. As explained, a prime mover can rotate a crank arm, whose movement is converted to reciprocal movement through a beam. The beam can include counterweights or a compressed air cylinder to help reduce load on the beam pump system during the upstroke. The beam can be attached to a polished rod by cables hung from a horsehead at the end of the beam. The polished rod can pass through a stuffing box and be operatively coupled to the rod string. As explained, the rod string can be lifted and lowered within the production tubing of a cased well by the reciprocal movement of the beam, enabling the downhole pump to capture and lift formation fluid(s) in a direction toward surface (e.g., with a flow vector component against gravity) in the tubing and through a pumping tee that directs the fluid into a flowline.

As an example, the prime mover may be an internal combustion engine or an electric motor that provides power to the pumping unit. As an example, a prime mover can deliver highspeed, low-torque power to a gear reducer, which converts that energy into the low-speed, high-torque energy utilized by the surface pump. As shown in FIG. 1, a beam pumping unit, beam pump system or merely beam pump, converts the rotational motion of the prime mover into a reciprocating vertical motion that lifts and lowers a rod string connected to a subsurface pump.

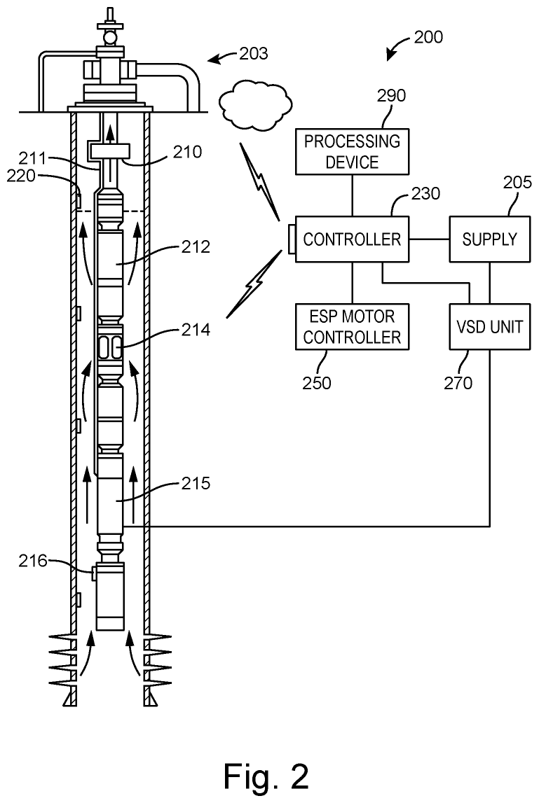

Referring now to FIG. 2, an example of an ESP system 200 is shown. The ESP system 200 includes a network 202, a well 203 disposed in a geologic environment, a power supply 205, an ESP 220, a controller 230, a motor controller 250, and a variable speed drive (VSD) unit 270. The power supply 205 may receive power from a power grid, an onsite generator (e.g., a natural gas driven turbine), or other source. The power supply 205 may supply a voltage, for example, of about 4.26 kV.

The well 203 includes a wellhead that can include a choke (e.g., a choke valve). For example, the well 203 can include a choke valve to control various operations such as to reduce pressure of a fluid from high pressure in a closed wellbore to atmospheric pressure. Adjustable choke valves can include valves constructed to resist wear due to high velocity, solids-laden fluid flowing by restricting or sealing elements. A wellhead may include one or more sensors such as a temperature sensor, a pressure sensor, a solids sensor, and the like.

The ESP 220 includes cables 222, a pump 222, gas handling features 223, a pump intake 224, a motor 225 and one or more sensors (e.g., temperature, pressure, current leakage, vibration, etc.). The well 203 may include one or more well sensors, for example, such as the commercially available OpticLine™ sensors or WellWatcher BriteBlue™ sensors marketed by Schlumberger Limited (Houston, Tex.). Such sensors are fiber-optic based and can provide for real time sensing of downhole conditions. Measurements of downhole conditions along the length of the well can provide for feedback, for example, to understand the operating mode or health of an ESP. Well sensors may extend thousands of feet into a well (e.g., 4,000 feet or more) and beyond a position of an ESP.

The controller 230 can include one or more interfaces, for example, for receipt, transmission or receipt and transmission of information with the motor controller 250, a VSD unit 270, the power supply 205 (e.g., a gas fueled turbine generator or a power company), the network 202, equipment in the well 203, equipment in another well, and the like. The controller 230 may also include features of an ESP motor controller and optionally supplant the ESP motor controller 250.

The motor controller 250 may be a commercially available motor controller such as the UniConn™ motor controller marketed by Schlumberger Limited (Houston, Tex.). The UniConn™ motor controller can connect to a SCADA system, the espWatcher™ surveillance system, etc. The UniConn™ motor controller can perform some control and data acquisition tasks for ESPs, surface pumps, or other monitored wells. The UniConn™ motor controller can interface with the Phoenix™ monitoring system, for example, to access pressure, temperature, and vibration data and various protection parameters as well as to provide direct current power to downhole sensors. The UniConn™ motor controller can interface with fixed speed drive (FSD) controllers or a VSD unit, for example, such as the VSD unit 270.

In accordance with various examples of the present disclosure, the controller 230 may include or be coupled to a processing device 290. Thus, the processing device 290 is able to receive data from ESP sensors and/or well sensors. Although shown schematically at certain locations, it should be appreciated that the ESP sensors and/or well sensors may be situated in various locations among the system 200. These sensors and well sensors may be used to measure various parameters disclosed above, such as drive current, motor temperature, pump intake pressure, pump discharge pressure, static intake pressure, drive frequency, pump flow rate, and the like.

The processing device 290 analyzes the data received from the sensors and/or other sensors, possibly with the addition of sensors from the VSD unit 270 and the controller 230, to provide enhanced and detection, which may then be used to control the operation of the ESP 220 to prolong its life and/or avoid downtime of the ESP 220 Generally, the processing device 290 may also be referred to as executing an AFP engine to carry out various operations of that engine described herein. The scope of the present disclosure is not intended to be limited to any particular location of various system 200 components; for example, processing and event detection may be carried out at the well site, in a cloud environment; at a remote surveillance center, and in any number of various centralized and distributed arrangements.

In some embodiments, the network 202 comprises a cellular network and the user device is a mobile phone, a smartphone, or the like. In these embodiments, the detection of an event of the ESP 220 may be transmitted to one or more users physically remote from the ESP system 200 over the cellular network 202. Certain embodiments of the present disclosure may include taking a remedial or other corrective action in response to detection of an event that may lead to a decrease in ESP 220 performance or to an outright failure of the ESP 220. The action taken may be automated in some instances, such that detection of a particular type of event automatically results in the action being carried out. Actions taken may include altering ESP 220 operating parameters (e.g., operating frequency) or surface process parameters (e.g., choke or control valves) to prolong ESP 220 operational life, stopping the ESP 220 temporarily, and providing a warning to a local operator, control room, or a regional surveillance center.

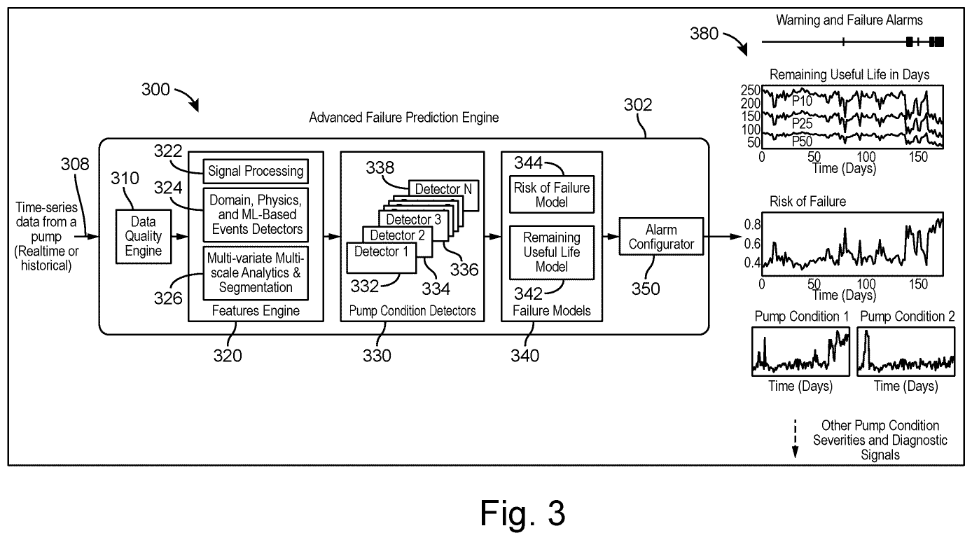

With referenced to FIG. 3, a failure prediction engine 300 (e.g., advanced failure prediction engine) is provided on a platform 302 and can be used at or with well sites for wells 102 and 203 (FIGS. 1 and 2). For example, engine 300 can be provided with and/or communicate with processing device 290 and/or controller 122 (FIGS. 1 and 2). In some embodiments, platform 302 is an edge device platform, a distributed computing platform, a remote server, or combinations thereof. Failure prediction engine 300 can be configured to predict life cycle and/or failure of any of the components associated with wells 102 and 203.

Platform 302 can be communicably connected to a communication interface wired or wireless such that platform 302 and the various components thereof can send and receive data. Platform 302 can include one or more processors implemented as a general purpose processor, a signal processor, an application specific integrated circuit (ASIC), one or more field programmable gate arrays (FPGAs), a group of processing components, or other suitable electronic processing components. Platform 302 can include memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory can be or include volatile memory or non-volatile memory. Memory can include database components, object code components, script components, or any other type of information structure for supporting the various activities and information structures described in the present application. Platform 302 can also include a user interface or be capable of communicating with a user device (e.g., computer, smart phone, etc.) The user interface can include a display, a keyboard, a keypad, a touch screen, etc. Platform 302 can distribute processing and operations across multiple servers or computers (e.g., that can exist in distributed locations). Platform 302 can include computer systems that provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with systems 100 and 200 (FIGS. 1 and 2).

Failure prediction engine 300 includes a data input 308. Data input 308 can be configured to receive time series data associated with one or more components. In some embodiments, data input 308 receives time series data from a pump or motor, sensors associated therewith, controllers associated therewith, and/or external sources. The time series data can be historical and/or real time data. Data can be collected over time and combined into streams of time series data. Each sample of the time series data can include a timestamp and a data value. The time series data can be raw timeseries data without significant organization or processing at the time of data collection or can be processed data (e.g., event data). The time series data can be generated from one or more streams of the raw timeseries data or processed time series data. Real-time measurements from a pump (e.g., drive speed, motor current, motor temperature, intake pressure, etc.) are used by the application of the failure prediction engine 300 in some embodiments. In some embodiments, the application can also run offline or on a periodic basis using historical time-series data.

Failure prediction engine 300 includes a data quality module or engine 310, a features module or engine 320, condition detectors 330, failure models 340, an alarm configurator 350. Failure prediction engine processes the time series data at input 308 and provides an output 380. Output 380 can be in the form of a report including alarm screens, graphs, text, graphics, icons, or other symbology. In some embodiments, the report is separated into different sections detailing wells and equipment. In some embodiments, the report can include life cycle and identify a corrective action to increase life cycle. The report can include compliance failures and actions to be taken to maintain parameter within compliance. The report can include predictive information and preventative maintenance.

In some embodiments, the report is generated in a portable document format (PDF), although it will be appreciated that any suitable format may be used. The compliance report may be generated dynamically, in response to a user request, in response to an event, in response to a life cycle reaching a threshold, or may be generated at a regular time interval. Accordingly, in some cases, previously generated reports may be stored in a database. In some embodiments, the report may be automatically or manually distributed to an inspector or maintenance personnel (e.g., via a third party system).

Failure prediction engine 300 is configured to provide on-going fault detection for systems 100 and 200 and control algorithms used in systems 100 and 200. Failure prediction engine 300 may automatically diagnose and respond to detected faults. The responses to detected or diagnosed faults may include providing an alert message to a user, a maintenance scheduling system, or a control algorithm configured to attempt to repair the fault or to work-around the fault.

Data quality engine 310 can be configured as an application. The applications can contain a unique data quality (DQ) engine which identifies issues in the real-time data streaming from the field and raises appropriate data quality flags indicating bad data or gauge failures for missing parameters or readings, outlier parameters or readings, broken thermocouple, etc. The data quality engine 310 makes analysis and determinations by failure prediction engine 300 more robust to lower quality data and helps enable/disable certain components depending on data availability and quality. Data quality engine 310 also adjusts prediction confidence depending on the availability and quality of data in some embodiments. Data quality flags are used to inform users about compromised data and prediction quality in some embodiments.

Features engine 320 includes a signal processing module 322, event detectors 324, and analytics and segmentation module 326. Features engine 320 is configured to extract valuable patterns and information from the raw signals provided by data quality engine 310. In some embodiments, features engine 320 generates hundreds of features at different time scales/frequencies/horizons.

Features engine 320 can be configured to denoise data and generate useful statistics (e.g., key performance statistics). The statistics can include averages, rate of change, certainty, etc. Features engine 320 is general purpose and its components are easily configurable in some embodiments. Features engine 320 can be easily repurposed to extract patterns and generate features across selected signals at different timescales. For example, in case of electrical submersible pumps installed in an oil well, the feature engine 320 can be configured to use different types and frequencies of real-time data such as i) daily oil production rates and periodic surface choke position changes, ii) ESP surveillance data such as motor current with sampling rate of seconds or minutes, and iii) electrical signature measurements that streams with very high frequency in the range of thousands of Hz. Features engine 320 leverages advanced multivariate unsupervised machine-learning techniques to detect patterns and shifts in patterns across multiple-signals and at multiple-timescales in some embodiments.

Signal processing module 322 can be configured to denoise data. Signal processing module 322 is a digital signal processing module and can include interpolators, filters, decimators, etc. Signal processing module can generate useful statistics and derivative signals related to rate of change, noise level, frequency, analysis, manipulation, and transformation of signals in a digital form. Signal processing module 322 can remove unwanted components, such as noise, or to extract useful parts of the signal using filters (e.g., low-pass filters, high-pass filters, band-pass filters, etc.) and can perform Fourier transforms (FTs), fast FT, convolution, and other mathematical operations.

Event detectors 324 are a domain, physics, and machine learning based event detectors in some embodiments. Event detector is configured to automatically detect different types of issues in equipment primarily based on existing human-expert knowledge in some embodiments. The events can be associate with a pump.

Analytics and segmentation module 326 is configured to use different types and frequencies of real-time data and events (via signal processing module 322 and detector 324) such as i) daily oil production rates and periodic surface choke position changes, ii) ESP surveillance data such as motor current with sampling rate of seconds or minutes, and iii) electrical signature measurements that streams with very high frequency in the range of thousands of Hz. Analytics and segmentation module 326 is a multi-variable, multiscale engine in some embodiments. Analytics and segmentation module 326 is configured to categorize data into meaningful segments to derive insights, patterns, or trends in some embodiments.

Detectors 330 can include a set of detectors 332, 334, 336, and 338. Set of detectors 332, 334, 336, and 338 can number from 1 to a N, where N is an integer, and each can be configured to detect a specific parameter, redundantly detect the specific parameter based upon the same data, or detect the same parameter based upon different data. In some embodiments, detectors 332, 334, 336, and 338 are pump condition detectors including advanced neural network-based machine-learning models. In some embodiments, other model types or detection techniques can be utilized. In some embodiments, detectors 332, 334, 336, and 338 are each designed from consultation with a domain and indicate severity of pump condition from a specific meaningful perspective. For example, motor temperature detectors indicate pump condition based on history of motor overheating, amount of overheating, trends in operating motor temperatures, instabilities in motor temperature, etc. In some embodiments, detectors 332, 334, 336, and 338 are configured to characterize pump health or condition from several specific perspectives related to mechanical, hydraulics, thermal, and electrical aspects of the pump and its operations. The characterization of the pump health is used to diagnose the cause of high risk of failure and take appropriate remedial actions in some embodiments.

In some embodiments, each of detectors 332, 334, 336, and 338 is configured to detect a condition. In some embodiments, each of detectors 332, 334, 336, and 338 is stateful and tracks historical, recent, and current conditions of the pump. Depending on the availability and quality of data, failure prediction engine 300 automatically enables/disables some detectors 332, 334, 336, and 338. For example, if data quality detector engine 310 has identified that a motor temperature sensor is broken or unreliable, then any detector of condition detectors 332, 334, 336, and 338 that uses motor temperature is disabled. The remaining of the detectors 332, 334, 336, and 338 that do not require motor temperature data continue to operate. A new condition detector can be added to the set of detectors 332, 334, 336, and 338 or replace one or more of detectors 332, 334, 336, and 338 as new types of information becomes commonly available through new sensors or technological advancements in existing instrumentation.

Diagnostics outputs from the engine 300 show the status of compromised condition detectors 332, 334, 336, and 338 as well as the underlying data quality flags. Since detectors 332, 334, 336, and 338 indicate domain-centric conditions, the analysis of missed failure detections help in determining new data/information that might be needed to predict those specific types of equipment failure. Thus, engine 300 can be used to guide what data is needed to predict failure of a certain type of equipment.

Models 340 are failure models in some embodiments. Models 340 include risk of failure model 344 and remaining useful life model 342 in some embodiments. Models 342 and 344 are neural network-based machine-learning models in some embodiments. The model 342 is configured to continuously evaluate pump conditions and output a risk of failure value between 0 to 1. Other scales can be used. The risk of failure value indicates likelihood of pump failing within X days or likelihood of pump running for longer than Y days if the current pump condition persists and does not improve. Values of X and Y and corresponding confidence level are provided by the model 342. For example, for a specific population of pumps, if the risk of failure value sustains at 0.7 then:
a. there is 50% probability that pump will run for at least 40 days (or 50% probability that pump will fail within next 40 days)
b. there is 25% probability that pump will run for at least 100 days (or 75% probability that pump will fail within next 100 days).
c. there is 10% probability that pump will run for at least 225 days (or 90% probability that pump will fail within next 225 days).
   If the risk of failure value increases, then the remaining useful life decreases. For example, if the risk of failure value increases to 0.9 and sustains at that level then:
a. There is 50% probability that pump will run for at least 25 days (or 50% probability that pump will fail within next 25 days)
b. There is 25% probability that pump will run for at least 50 days (or 75% probability that pump will fail within next 50 days).
c. There is a 10% probability that pump will run for at least 175 days (or 90% probability that pump will fail within next 175 days).
   The values given above are exemplary. Model 342 is configured to automatically fine-tune for the target population as more pump failures are registered. This further improves the confidence in remaining useful life predictions.

Alarm configurator 350 is an application or module that is configured to provide various options for users to set conditions to trigger alarms based on one or combinations of several parameters and conditions including risk of failure, remaining life, confidence level, run time, etc. For example, a threshold alarm can be set on risk of failure reaching a threshold for system 100 or 200 to take immediate actions. Alternatively, or additionally, the threshold alarm can be set on the remaining useful life being below a threshold to help with planning of workover operation, maintenance, inventory management, etc. In some embodiments, advanced alarms can also be configured which depend on various parameters in addition to risk of failure and/or remaining useful life, such as total runtime, detector level thresholds, detector severities, and metadata related to pump or well, etc. The alarm configuration can be changed as needed based on the change in operational priorities and/or the way failure risk outputs are being used.

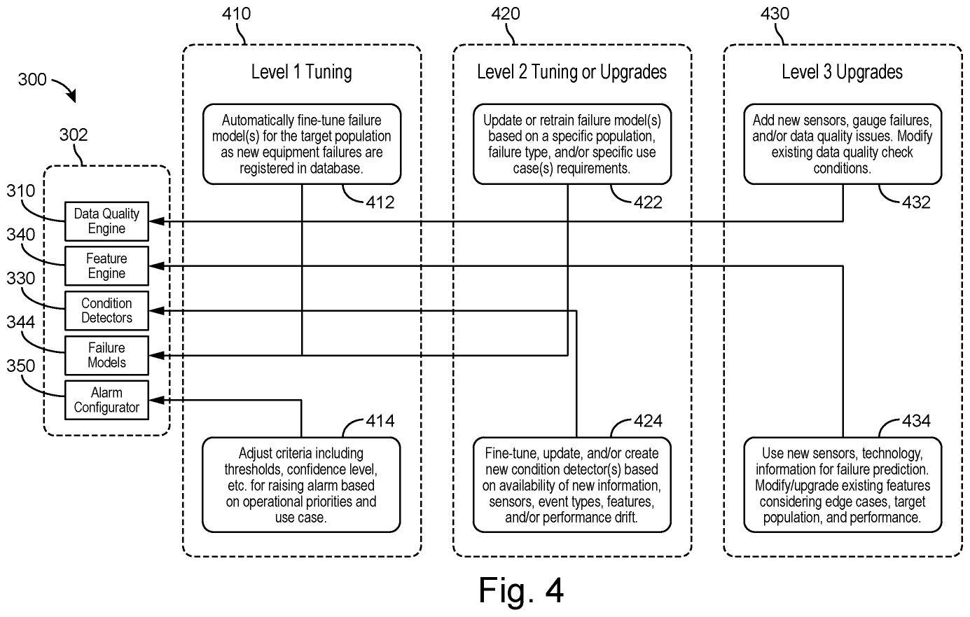

With reference to FIG. 4, the architecture of the engine 300 is modular and allows modifications, upgrades, and adding of components using a level 1 tuning operation 410, a level 2 tuning operation 420, and/or a level 3 tuning operation 430. For example, models 340 and detectors 330 can be updated or retrained based upon a specific population failure type, and/or specific use case requirement in an operation 422 in a level 2 tuning operation 420. The upgrade can include providing new detectors and/or enabling or disabling detectors. In an operation 424 in level 2 tuning operation 420, detectors 330 can be fine-tuned, updated or created based upon availability of new information, sensors, event types, features, and/or performance drift. In another example, level 1 tuning operations 410 can include an operation 412 to automatically fine tune models 340 for the target population as new equipment failures are registered in a database. Level 1 tuning operations 410 can include an operation 414 that adjusts criteria including thresholds, confidence level, etc. for raising an alarm base upon operational priorities and use case. Level 3 tuning operations 430 can include an operation 432 that modifies existing data quality check parameters for data quality engine 310 in response to new sensors, gauge failures, and/or quality issues. Level 3 tuning operations 430 can include an operation 434 that modifies feature engine 320 in response to new sensors or technology related to failure prediction and can consider edge cases, target populations, and performance.

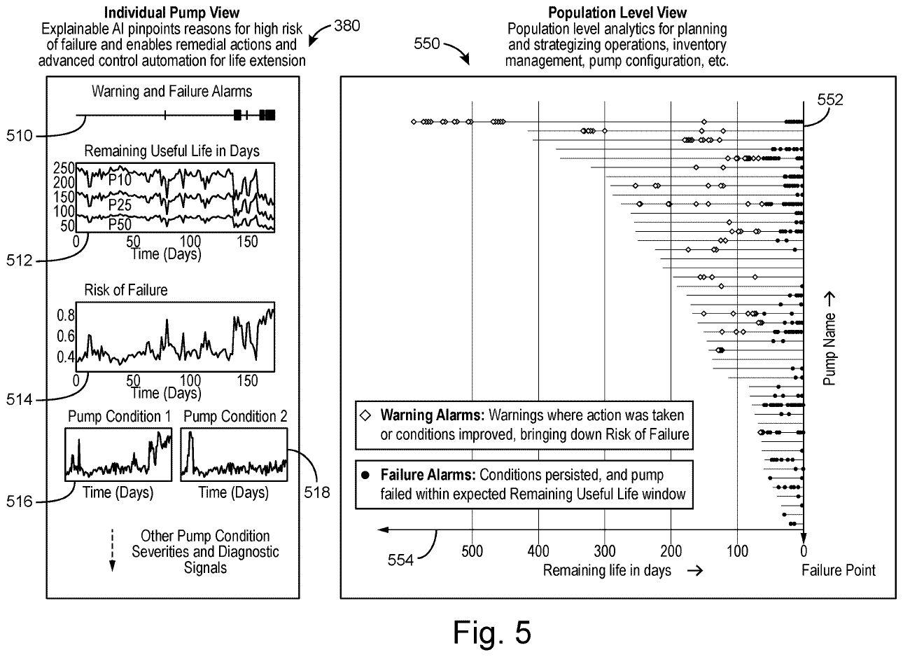

With reference to FIG. 5, failure prediction engine 300 is configured to continuously provide output 380. Output 380 can include different types of actionable insights including but not limited to: a warning and failure alarm 510, a remaining useful life graph 512, a risk of failure graph 514, a pump condition graph 516, and another pump condition graph 518 which are provided on an individual equipment (e.g., pump) view.

Warning and failure alarm 510 provides graphical indications of warning or failure alarms to raise attention. These alarms are configured in the alarm configurator 350 (e.g., as discussed). Warning alarms are alarms where risk of failure did not sustain and decreased due to conditions improving and/or actions taken. Failure alarms are the alarms where the pump is predicted to fail within a window.

Graph 512 shows remaining useful life of a pump at a 50%, 25%, and 10% likelihood of the pump running longer than the corresponding remaining useful life value (P50, P25, and P10). An X axis of graph 512 indicates time and the Y axis of graph 512 indicates remaining useful life in days. Graph 514 shows risk of failure on a scale from 0 to 1 on the Y axis over time on the X axis. Graphs 516 and 518 show pump condition severities on a Y axis over time on an X axis Graphs 516 and 518 can help identify which pump conditions are responsible for high risk of failure and help users take appropriate actions. Additional diagnostic signals being output from the failure prediction engine 300 can assist in further diagnosis and root causes analysis to exactly pinpoint the condition(s), signals, or situations responsible for the high risk of failure. Failure prediction engine 300 is configured to assist explainability and hence, every prediction made by the underlying artificial intelligence models as well as the overall engine workflow and outputs are traceable and explainable in some embodiments. Output 380 for an individual pump level can help the operations team identify reasons for high risk of failure and take remedial actions. Additionally, output 380 helps advanced automation of pump controls extend life of a pump.

Output 380 can also include a population level view providing population analytics information for planning and strategizing operations, inventory management, pump configuration, maintenance, etc. The population level view can include a graph 550 having an X axis 554 representing remaining life in days and a Y axis 552 representing different pumps. Each bar in the graph 550 represents useful life for each pump and provides easy comparison across the population.

Graph 550 provides population or field level outputs and analytics that can help proactively plan for maintenance, workover, or replacement. Population level analytics can also help evaluate and update standard pump operating strategies, pump configurations, pump control set points, etc. Failure analytics can help in failure diagnostics and evaluation of various pump hardware components, suppliers, etc.

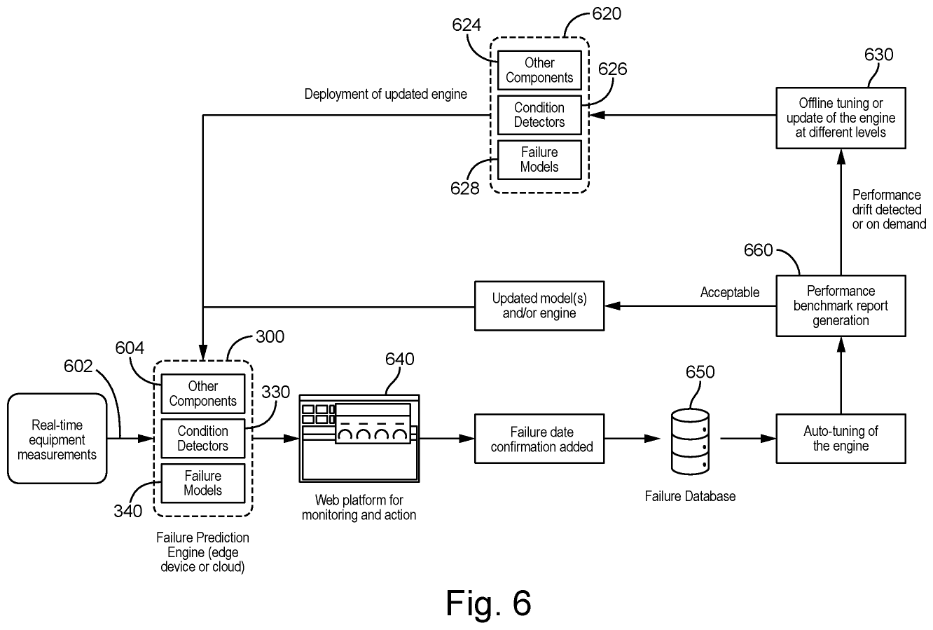

With reference to FIG. 6. a failure prediction system workflow for failure prediction engine 300 can be used after deployment. Failure prediction engine 300 (e.g., residing on edge device or on the cloud) provides outputs for display on an existing surveillance web platform 640 for monitoring pump conditions. Individual pump level, ranking of pumps in terms of severities, historical risk of failures, population level analytics, etc. can be visualized on platform 640. Platform 640 also allows users to take actions remotely and adjust pump controls in an operation 630. As pumps fail and their failure dates confirmations are added to a database 650, the failure model is automatically tuned and confidence interval in the predictions are improved. Failure prediction engine 300 can include report generation tool that automatically generates a performance benchmark report 660. If results are acceptable, then the updated model(s) are deployed in failure prediction engine 300. The updated engine can be deployed as engine 300. If a significant drift in performance has been detected or because of various other reasons related to enhancements, offline tuning or upgrade of failure prediction engine 300 can be initiated which depending on the requirement goes through different levels of tuning. Updated engine 620 is then tested and redeployed.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (i.e., permanent or fixed) or moveable (i.e., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A pump system for a pump disposed within a well, the pump system comprising:
a controller comprising a failure prediction engine configured to predict life cycle and failure, wherein the failure prediction engine comprises a data quality (DQ) engine configured to identify receive real-time streaming data associated with the well and provide data quality flags and a features engine configured to extract patterns, wherein the features engine is configured to receive the data quality flags from data quality engine and the real-time streaming.

2. The pump system of claim 1, wherein the data quality flags indicate missing parameters or readings, or outlier parameters or readings.

3. The pump system of claim 1, wherein the data quality engine is configured as an application.

4. The pump system of claim 1, wherein the features engine is configured to denoise the real-time streaming data and generate key performance statistics.

5. The pump system of claim 4, wherein the key performance statistics comprise averages, rate of change, and certainty.

6. The pump system of claim 1, wherein the failure prediction engine is configured to automatically enable/disable condition detectors in response to the data quality flags.

7. The pump system of claim 1, wherein the features engine uses advanced multivariate unsupervised machine-learning techniques to detect the patterns and shifts in the patterns across multiple-signals and at multiple-timescales.

8. A failure prediction engine for energy resource processing, comprising:
a data quality engine configured to identify receive real-time streaming data associated with the energy resource processing and provide data quality flags;
a features engine configured to extract patterns, wherein the features engine is configured to receive the data quality flags from the data quality engine and the real-time streaming; and
a plurality of condition detectors, wherein each condition detector is configured to detect a condition, wherein the failure prediction engine is configured to automatically enable/disable at least one of the condition detectors in response to the data quality flags.

9. The failure prediction engine of claim 8, further comprising:
models comprising a risk of failure model and remaining useful life model.

10. The failure prediction engine of claim 9, further comprising:
an alarm configurator configured to provide various options for users to set conditions to trigger alarms in response at a risk of failure, remaining life, confidence level, or run time.

11. The failure prediction engine of claim 8, wherein the failure prediction engine is configured to automatically enable/disable condition detectors in response to the data quality flags.

12. The failure prediction engine of claim 8, wherein the features engine is configured to denoise the real-time streaming data and generate key performance statistics.

13. The failure prediction engine of claim 12, wherein the key performance statistics comprise averages, rate of change, and certainty.

14. The failure prediction engine of claim 8, wherein the failure prediction engine is configured to automatically enable/disable condition detectors in response to the data quality flags.

15. The failure prediction engine of claim 8, wherein the features engine uses advanced multivariate unsupervised machine-learning techniques to detect the patterns and shifts in the patterns across multiple-signals and at multiple-timescales.

16. A well site including a pump system for a pump disposed within a well, the well site comprising:
a failure prediction engine, comprising:
a data quality engine;
a features engine;
condition detectors;
failure models; and
an alarm generator, wherein the failure prediction engine is configured to provide tuning for the alarm configurator and the failure models, tuning for the condition detectors, and tuning a feature engine.

17. The well site of claim 16, wherein the failure prediction engine is configured to provide tuning for the data quality engine.

18. The well site of claim 16, wherein the failure prediction engine is configured to update the failure models and the detectors based upon a specific population failure type or a specific use case requirement.

19. The well site of claim 16, wherein the failure prediction engine is configured tune the detectors based upon performance drift.

20. The well site of claim 16, wherein the failure prediction engine is configured to modify the feature engine in response to new sensors.
